(19) United States
(12) Patent Application Publication
(10) Pub. No.: US 2022/0241904 A1
(43) Pub. Date: Aug. 4, 2022

(54) COATED ABRASIVE PARTICLES, COATING METHOD USING SAME, COATING SYSTEM AND SEALING SYSTEM

(71) Applicant: Siemens Energy Global GmbH & Co. KG, Munich, Bayern (DE)

(72) Inventors: Johannes Döhnert, Berlin (DE); Francis Ladru, Berlin (DE); Ingo Reinkensmeier, Fröndenberg (DE); Thorsten Schulz, Berlin (DE); Britta Stöhr, Berlin (DE)

(73) Assignee: Siemens Energy Global GmbH & Co. KG, Munich, Bayern (DE)

(21) Appl. No.: 17/611,152

(22) PCT Filed: May 13, 2020
(86) PCT No.: PCT/EP2020/063305

§ 371 Date: Nov. 14, 2021

(30) Foreign Application Priority Data
May 20, 2019 (DE) 10 2019 207 353.0

(51) Int. Cl. B23K 35/368; B23K 35/02; C23C 4/10; B32B 15/01

(52) U.S. Cl. CPC B23K 35/368; B23K 35/025; B23K 35/0233; B23K 2101/001; C23C 4/10; B32B 15/01; B23K 35/0244

(57) ABSTRACT

A soldering method in which abrasive particles, in particular cubic boron nitride, are applied in a matrix composed of a solder material and are intended to have better adhesion in the matrix material. The particle which includes an abrasive particle, in particular of cubic boron nitride, is coated with a metal. A method for producing a layer on a substrate, wherein a solder material is applied as metallic matrix material such with particles, in particular solder material in the form of a soldering paste, a soldering tape, a solder powder, by an application method, in particular by a welding process or a thermal spraying process.

### CROSS REFERENCE TO RELATED APPLICATIONS

This application is the US National Stage of International Application No. PCT/EP2020/063305 filed 13 May 2020, and claims the benefit thereof. The International Application claims the benefit of German Application No. DE 10 2019 207 353.0 filed 20 May 2019. All of the applications are incorporated by reference herein in their entirety.

### FIELD OF INVENTION

The invention relates, in particular, to a soldering method in which abrasive particles, in particular cubic boron nitride, are applied in a matrix composed of a solder material and are intended to have better adhesion in the matrix material.

### BACKGROUND OF INVENTION

The optimum gap in gas turbines or aircraft engines has a critical influence on efficiency and performance of these machines. An established system for adjusting this is a rubbing-in layer on the housing side (e.g. honeycombs), into which the rotating parts (e.g. turbine rotor blades) rub in. In this way, the optimum gap is ground in, independently of manufacturing tolerances, asymmetric housing deformation, rotor displacement, etc.

Furthermore, armoring of the blade tips with, for example, cubic boron nitride (cBN) in order to protect the blade tips during rubbing-in is standard in industry.

However, the application of the cBN is problematical since cBN does not form particularly good bonds with other materials. Furthermore, the embedding material (matrix) has to be resistant to high temperatures for the turbine sector. Embedding in, for example, resin derivatives as in the construction of abrasives (US 2013/004938 A1) is therefore not possible.

The better the bonding of the cBN to the rotating components, the more effective is the ultimate grinding effect. The probability of the particles breaking out during the grinding-in process is countered.

Known manufacturing methods are electrochemical application or inductive soldering-on by means of special cBN tapes, but these are costly and technically complex.

U.S. Pat. No. 8,308,830 B2 discloses coated particles of cubic boron nitride which have two layers of coatings.

U.S. Pat. No. 4,399,167 discloses coating of abrasive particles with metal.

U.S. Pat. No. 10,183,312 B2 discloses coated abrasive particles with a soldering layer, with this soldering layer forming the matrix of the layer to be produced.

### SUMMARY OF INVENTION

It is therefore an object of the invention to solve the abovementioned problem.

The object is achieved by a particle, a method, a layer system and a sealing system as claimed.

Further advantageous measures which can be combined with one another in any way in order to achieve further advantages are listed in the dependent claims.

Experiments have shown that the solder results can be improved considerably when the abrasive particles such as cBN grains, as illustrative abrasive particle here, have been provided with an additional readily bonding/reactive coating instead of pure abrasive grains. These metallic coatings are, in particular, nickel (Ni) or titanium (Ti).

Advantages are—the bonding and embedding of the cBN grains is significantly improved. The holding force and thus the abrasive action of the cBN are thus increased and—the surface quality is significantly improved. For formation of the gap, a small manufacturing tolerance or a high surface quality is necessary. The gaps can thus be made narrower and lead to a higher efficiency of the gas turbine.

### BRIEF DESCRIPTION OF THE DRAWINGS

The figures and the description present only working examples of the invention.

FIG. 1 shows a coated abrasive particle,

FIG. 2 shows a layer system.

### DETAILED DESCRIPTION OF INVENTION

The particle 1 comprises a core of an abrasive particle 4, in particular cubic boron nitride (cBN), in its interior and a surrounding layer 7 of a metal, advantageously titanium (Ti) or nickel (Ni), which leads to better bonding in a solder material.

The term metal is intended to refer to metallic materials, i.e. including metallic alloys.

FIG. 2 schematically depicts a layer system 10.

The layer system 10 is advantageously a turbine component of a sealing system which is to have an abrasive layer 22 at one end.

The component as layer system 10 has a substrate 13, in particular a metallic superalloy and very particularly advantageously a nickel- or cobalt-based superalloy.

An abrasive layer 22 or a material comprising abrasive particles, in particular cubic boron nitride (cBN), is to be applied to the substrate 13, in particular to its surface 16. This should occur by means of a soldering process.

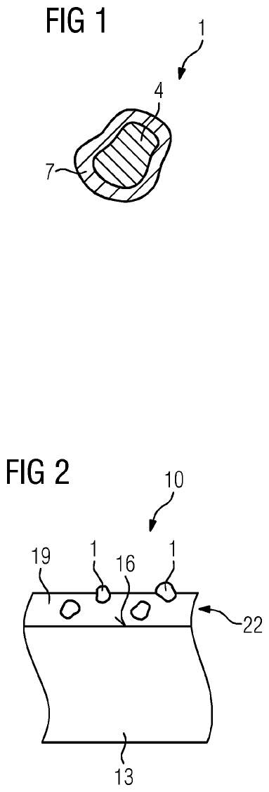

A solder material 19 in the form of a plasma spraying process, HVOF or a soldering paste or in the form of tapes, which comprises the particles 1 as per FIG. 1, is used here.

The applied solder material 19 then forms the outer layer 22. The solder material 19 has, in particular, a melting point which is at least 10 K lower, in particular at least 20 K lower, than that of the material of the substrate 13.

As melting point reducers in the solder, advantage is given to using typical elements such as boron (B), silicon (Si), phosphorus (P), hafnium (Hf), zirconium (Zr) or else manganese (Mn) and/or germanium (Ge).

The particles 1 are both entirely present in the layer 22 and also project from the surface of the layer 22.

The layer 22 thus comprises three different materials, namely that of the abrasive particle 4, that of the layer 7 around the particle 4 and the solder material 19.

The layer 22 is then advantageously applied only to the blade tip of a turbine rotor blade in such a sealing system.

The turbine rotor blade can have, and in the case of gas turbines will generally likewise have, metallic and/or ceramic coatings on the blade airfoil and/or on the blade platform, but these coatings do not comprise the particles 1.

The stator or the housing of a turbine, in particular a gas turbine, also has a protective coating into which this abrasive layer 22 rubs. The coating on the housing or stator can be purely metallic, purely ceramic or comprise a layer system of a metallic bonding layer and an outer ceramic layer or a plurality of ceramic layers.

The layers or the layer system of the housing are made so that they are mechanically softer than the abrasive layer 22, so as to allow grinding-in. This can be achieved via the composition of the metallic or ceramic coating and/or also by setting of the porosities of the layer or the layers and also advantageously by means of longitudinal grooves introduced by way of a laser beam or water jet.

1. A particle, comprising:
an abrasive particle, and
a coating of metal on the abrasive particle.

2. The particle as claimed in claim 1,
wherein the coating of metal comprises titanium (Ti) and/or nickel (Ni).

3. The particle as claimed in claim 2,
wherein only one coating of metal is present around the abrasive particle.

4. A method for producing a layer, comprising:
using particles as claimed in claim 1.

5. The method as claimed in claim 4,
wherein the particles are or have been mixed with a metallic matrix material and are applied.

6. A method for producing a layer on a substrate, comprising:
applying a solder material as metallic matrix material with particles as claimed in claim 1 by an application method,
wherein the melting point of the solder material is at least 10 K lower than that of the substrate.

7. A layer system, comprising:
a substrate comprising a layer,
wherein the layer comprises a solder material and particles as claimed in claim 1,
wherein the solder material has a melting point which is 10 K lower than that of the material of the substrate.

8. A sealing system, comprising:
a stator and rotating parts comprising a layer system as claimed in claim 7.

9. The particle as claimed in claim 1,
wherein the abrasive particle comprises cubic boron nitride.

10. The particle as claimed in claim 3,
wherein only one metal is present around the abrasive particle.

11. The method as claimed in claim 6,
wherein the solder material is in the form of a soldering paste, a soldering tape, and/or a solder powder.

12. The method as claimed in claim 6,
wherein the application method comprises a welding process or a thermal spraying process.

13. The method as claimed in claim 6,
wherein the melting point of the solder material is at least 20 K lower than that of the substrate.

14. The layer system as claimed in claim 7,
wherein the substrate comprises a metallic substrate.

15. The layer system as claimed in claim 7,
wherein the melting point of the solder material is at least 20 K lower than that of the substrate.

16. The sealing system as claimed in claim 8,
wherein the layer system is on the rotating part.

17. The sealing system as claimed in claim 8,
wherein the layer system is on a rotor blade.
